(19) United States
(12) Patent Application Publication
(10) Pub. No.: US 2022/0120298 A1
(43) Pub. Date: Apr. 21, 2022

(54) ATTACHMENT CLIPS FOR MOUNTING ON CORDS

(71) Applicant: Nilin Patel, Raleigh, NC (US)

(72) Inventor: Nilin Patel, Raleigh, NC (US)

(21) Appl. No.: 17/562,063

(22) Filed: Dec. 27, 2021

(51) Int. Cl. F16B 2/22; A44B 6/00

(52) U.S. Cl. CPC F16B 2/22; A44B 6/00

(57) ABSTRACT

Presented are attachment clips for mounting and displaying on cords. The attachment clips comprises cord attachment portion to allow insertion of one or more cords. The cord attachment portion comprises two jaw portions wherein each Jaw portion has a base attachment portion and a tip portion on the opposite side. A through- hole extends between the jaw portions and an aperture is formed between the tip portions of both opposing jaw portions. A centering element is disposed in inner side of each jaw portion. Several alternative embodiments of attachment clips are disclosed in detail. The attachment clips are easy to attach to cords, provides aesthetic appeal and could be used for attaching various accessories to the cords.

### TECHNICAL FIELD OF INVENTION

The present invention generally relates to attachment clips and more particularly, it pertains to attachment clips that can be removably mounted and displayed on cords.

### BACKGROUND

Many people carry accessories such as but not limited to earphones, keys, mini-speakers, lights, pen, bracelets and so on in their pockets, purses, bags and the like. After use of these accessories, people sometimes forget their accessories, requiring them to purchase same accessory again, thus wasting their money and time.

Further, many people want to style themselves and thus, they attach various decorative items on their clothing articles such as shirts, pants, shoes or the like. The decorative items could include chains, jewelries, armbands, key chains/key fobs or the like. However, attaching various decorative items on their clothing articles possesses few challenges as it takes time and effort to properly and quickly attach the decorative items on their clothing articles.

Various items have been attempted in the prior art to solve the above mentioned problem. The items could be attached to drawstrings, laces or the like and the items serve the purpose of styling as well as securing the accessories to the drawstrings, laces or the like.

For example, U.S. Pat. No. 10,638,805B2 discloses a unitary drawstring accessory configured to be secured to a drawstring, the accessory including a body; and a channel including a first end, a second end, a length from the first end and the second end, at least one inflection point disposed along the length of the channel, wherein the channel is disposed on a portion of the body, wherein the channel is configured to require manipulation of the drawstring such that a portion of the drawstring may be seated in the channel and upon removal of such manipulation, the portion of the drawstring is frictionally secured in the channel

US20130192031A1 discloses a system for personalizing items. The system includes a body. The system also includes a hole, wherein the hole passes completely through at least a portion of the body.

US20150089975A1 discloses Indicia-bearing objects for mounting, identifying and displaying on cords, strings, cables, laces, etc. are provided. The objects may ornamental and/or identifying objects configured for mounting and displaying on electrical and/or electronics cords, including cords for consumer electronics such as ear-bud cords and phone cords, as well as on lanyards, draw strings, pull strings, shoe laces, necklaces, bracelets, and the like. Several alternative constructions are disclosed in detail. The objects may additionally incorporate visual features in the form of an LED light (for example), and/or audio features via a prerecorded audio message, sound, musical composition (or the like).

The existing prior art(s) do not provide an effective solution due to its cumbersome design and difficulty in use. Thus, there is a need for attachment clip that is easy to attach to the cords, provides aesthetic appeal and could be used for attaching various accessories to the cords.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

It is an object of the present invention to provide an attachment clip that is removably mounted on a cord.

Embodiments of the present invention disclose am attachment clip configured for mounting on a cord. The attachment comprises a base, a cord attachment portion and an accessory attachment portion disposed on opposite sides of the base. The cord attachment portion comprises two jaw portions wherein each jaw portion has a base attachment portion and a tip portion on the opposite side. A first through-hole extends between the jaw portions and a first aperture is formed between the tip portions of both opposing jaw portions. The accessory attachment portion is configured for retaining at least an accessory. Each jaw portion further includes a centering element disposed in inner side of each jaw portion.

In an embodiment, the accessory comprises at least one item selected from: a pen, an ear bud, a light, a key, a bottle, a mini-speaker, a pencil and a bracelet.

In another embodiment, the cord comprises at least one item selected from: a drawstring, a lace, a string, a wire, an electronic item, a necklace, a thread and a cable.

Embodiments of the present invention disclose an attachment clip configured for mounting on a cord. The attachment clip comprises a cord attachment portion connected to a decorative element. The cord attachment portion comprises two jaw portions wherein each jaw portion has a clip attachment portion and a tip portion on the opposite side. A through-hole extends between the jaw portions and an aperture is formed between the tip portions of both opposing jaw portions. The inner portion of each jaw portion has a corrugated profile for gripping the cord.

In an embodiment, the decorative element comprises at least one item selected from: spheres, polygons, ball configurations, sporting goods configurations, three dimensional character configurations, animals, figures, symbols, writing, and advertisement items and LED lights and so on.

Embodiments of the present invention disclose a modular two-piece attachment clip configured for mounting on a cord. The modular two-piece attachment clip comprises a cord attachment portion removably connected to an attachment element. The cord attachment portion comprises two jaw portions and a base. Each jaw portion has a clip attachment portion and a tip portion on the opposite side. A through-hole extends between the jaw portions and an aperture is formed between the tip portions of both opposing jaw portions. Each jaw portions includes a centering element disposed in inner side of each jaw portion. The attachment element comprises a connector element; and the base further comprises a connection portion for removable connection to the connector element of the attachment element

In an embodiment, the connector element and/or connection portion comprises surface features selected from a group consisting of: male-female projections, friction locks, snap-fit locks, key and keyways, pins, screws and luer-locks.

In an embodiment, the attachment element could include an item selected from a group consisting of: a cord attachment portion, a decorative element, a combination of the cord attachment portion and the decorative element, and an accessory.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a front view of an article of clothing having drawstrings upon which a plurality of one embodiment of the attachment clip are used;

FIG. 2 illustrates a front view of an article of clothing having drawstrings upon which a plurality of other embodiment of the attachment clip are used;

FIGS. 3-9 illustrates front perspective views of various embodiments of the attachment clips of the present invention;

FIG. 10 shows an embodiment of the modular attachment clip of the present invention in the disassembled state;

FIG. 11 shows an embodiment of the modular attachment clip of the present invention in the assembled state;

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

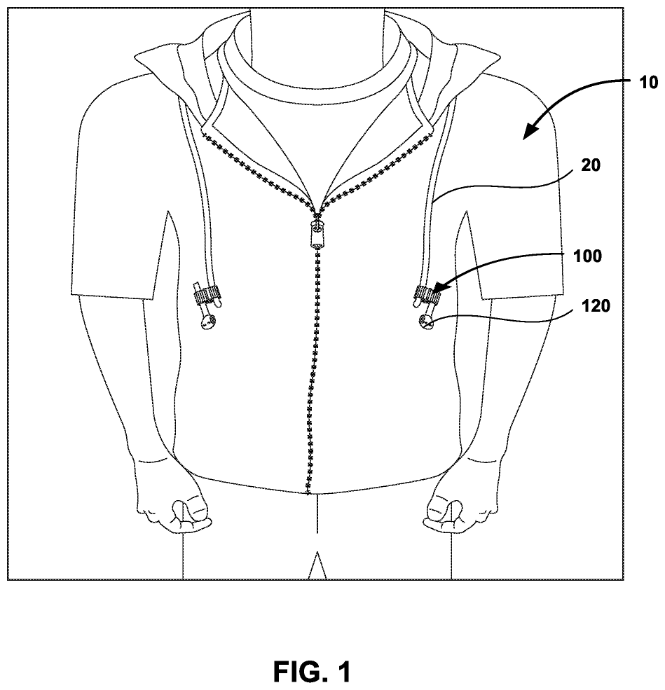

The various features and embodiments of attachment clips of the present invention will now be described in conjunction with the accompanying figures, namely FIGS. 1-11.

FIG. 1 illustrates a front view of an article of clothing 10, e.g., a hooded sweatshirt, comprising cords 20 (drawstrings) upon which a plurality of attachment clips 100 according to an embodiment of the present invention is used. At least one attachment clip 100 of the present invention is secured to the cords 20. The hooded sweatshirt 10 has conventional design features and is commercially available in the market. The attachment clip 100 is secured to an end of cord 20 which will be described in greater detail in the below description with the help of accompanying figures. Further, the attachment clip 100 is attached to an accessory 120 i.e. an earphone. Further, in another embodiment, the article of clothing 10 could also include but not limited to shoes, sandals, trousers, jackets and so on. Further, the accessories 120 could include any item that could be attached to the attachment clip 100. The accessories 120 could be any house-hold item and/or a useful object. The accessories 120 could include but not limited to: pens, ear buds, lights, keys, bottles, mini-speakers, lights, pen, pencils, ear-bands, and bracelets and so on.

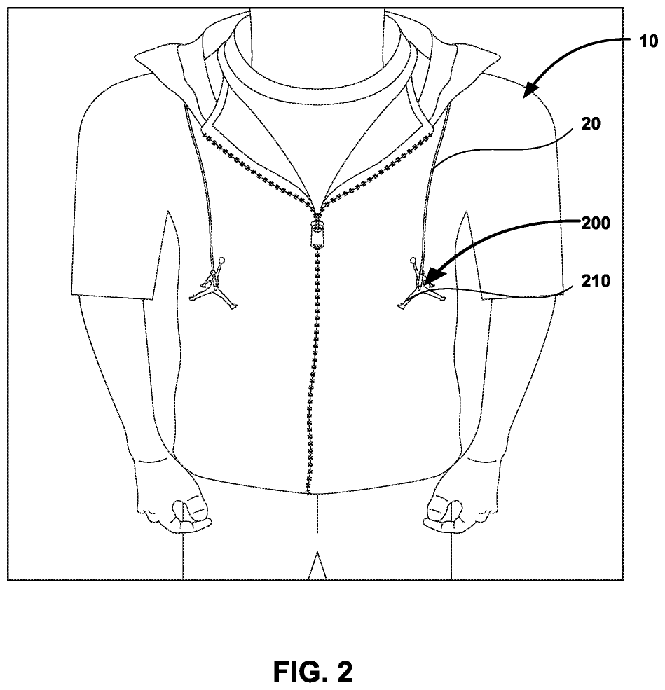

FIG. 2 illustrates a front view of an article of clothing 10, e.g., a hooded sweatshirt, comprising cords 20 (drawstrings) upon which a plurality of attachment clip 200 according to another embodiment of the present invention is used. At least one attachment clip 200 of the present invention is secured to the cords 20 which will be described in greater detail in the description to follow. The hooded sweatshirt 10 has conventional design features and is commercially available in the market. The attachment clip 200 is secured to an end of cord 20. Further, the attachment clip 200 includes a decorative element 210. The decorative element 210 provides an aesthetic appeal and/or decorative effect to the attachment clip 200. Further, in an another embodiment, the article of clothing 10 could also include but not limited to shoes, sandals, trousers, jackets and so on.

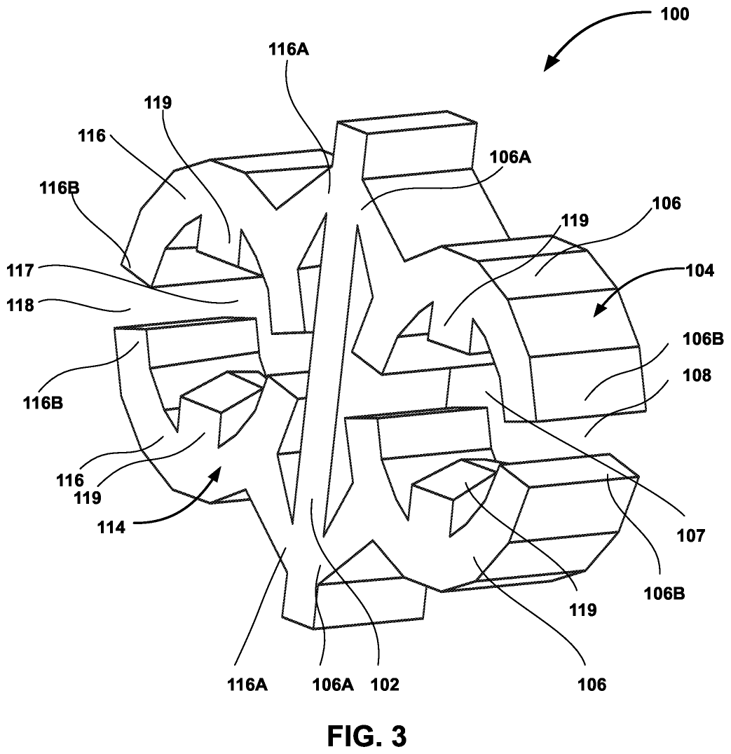

FIGS. 3-9 illustrate front perspective views of various embodiments of the attachment clips of the present invention.

Referring to FIG. 3, the attachment clip 100 is a symmetrical object capable of being attached to an end of cord 20 (FIG. 1) or the like. The attachment clip 100 comprises a base 102. A cord attachment portion 104 and an accessory attachment portion 114 are disposed on opposite sides of the base 102.

The cord attachment portion 104 comprises two jaw portions 106. Each jaw portion 106 has a base attachment portion 106A and a tip portion 106B on the opposite side. A first through-hole 107 extends between the jaw portions 106. A first aperture 108 is formed between the tip portions 106B of both opposing jaw portions 106. The first aperture 108 provides a passageway for one or more cords 20 (FIG. 1) or the like from an external location to first through-hole 107 and vice versa. First through-hole 107 is generally dimensioned and configured to accommodate and permit passage of the full dimensions of one or more cords 20 (FIG. 1) or the like. In an embodiment, the jaw portions 106 are made of a substantially flexible material to allow insertion of one or more cords 20 in the first through-hole 107 and vice versa.

The accessory attachment portion 114 comprises two clamp portions 116. Each clamp portion 116 has a base attachment portion 116A and a tip portion 116B on the opposite side. A second through-hole 117 extends between clamp portions 116. A second aperture 118 is formed between the tip portions 116B of both opposing clamp portions 116. The second aperture 118 provides a passageway for one or more accessories 120 (FIG. 1) or the like from an external location to second through-hole 117 and vice versa. Second through-hole 117 is generally dimensioned and configured to accommodate and permit passage of the full dimensions of one or more accessories 120. In an embodiment, the clamp portions 116 are made of a substantially flexible material to allow insertion of one or more cords 20 in the second through-hole 117 and vice versa.

Both jaw portions 106 and the clamp portions 116 further includes a centering element 119 disposed substantially in midway of inner side of each jaw portions 106 and the clamp portions 116 respectively. The centering element 119 is basically a raised projection and the centering element 119 provides various functions and/or advantages. The centering element 119 keeps the cords 20 (FIG. 1) and/or accessories 120 or the like in a centered position. Further, the centering element 119 securely holds the cords 20 (FIG. 1) and/or accessories 120 or the like in the first through-hole 107 and second through-hole 117 respectively such that the attachment clip 100 and/or accessories 120 does not accidentally slip or fall out when the attachment clip 100 is attached to cords 20 (FIG. 1) and/or accessories 120 (FIG. 1) or the like. Both jaw portion 106 and the clamp portion 116 have a substantially c-shape, however, other shapes of jaw portion 106 and/or and the clamp portion 116 is possible and can include shapes such as: L shape, V shape, linear shape, zigzag shape and so on.

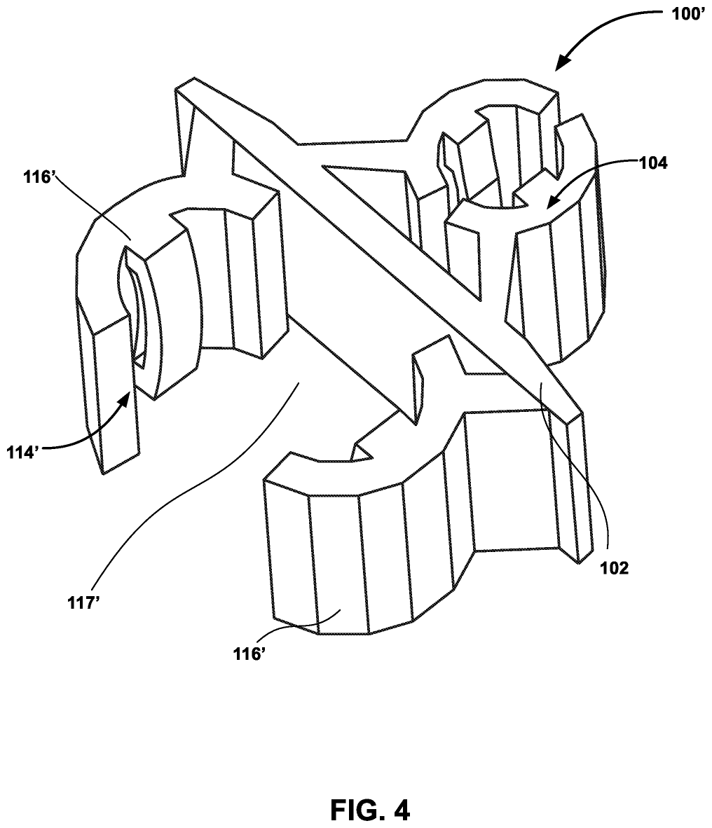

Referring to FIG. 4, an attachment clip 100′ is shown, according to another embodiment of the present invention, wherein the attachment clip 100′ is an asymmetrical object. The attachment clip 100′ is capable of being attached to an end of cord 20 (FIG. 1) or the like. The attachment clip 100′ is similar to the attachment clip 100 shown in FIG. 3 except for modifications associated with the geometrical features of the second through-hole and clamp portions of the attachment clip. The attachment clip 100′ comprises a base 102. A cord attachment portion 104 and an accessory attachment portion 114′ are disposed on opposite sides of the base 102. A second through-hole 117′ extends between clamp portions 116′.

As seen in FIG. 4, the second through-hole 117′ is enlarged compared to second through-hole 117 of FIG. 3. The clamp portions 116′ are spaced apart to accommodate accessories 120 (FIG. 1) of bigger shapes and sizes as compared to FIG. 3.

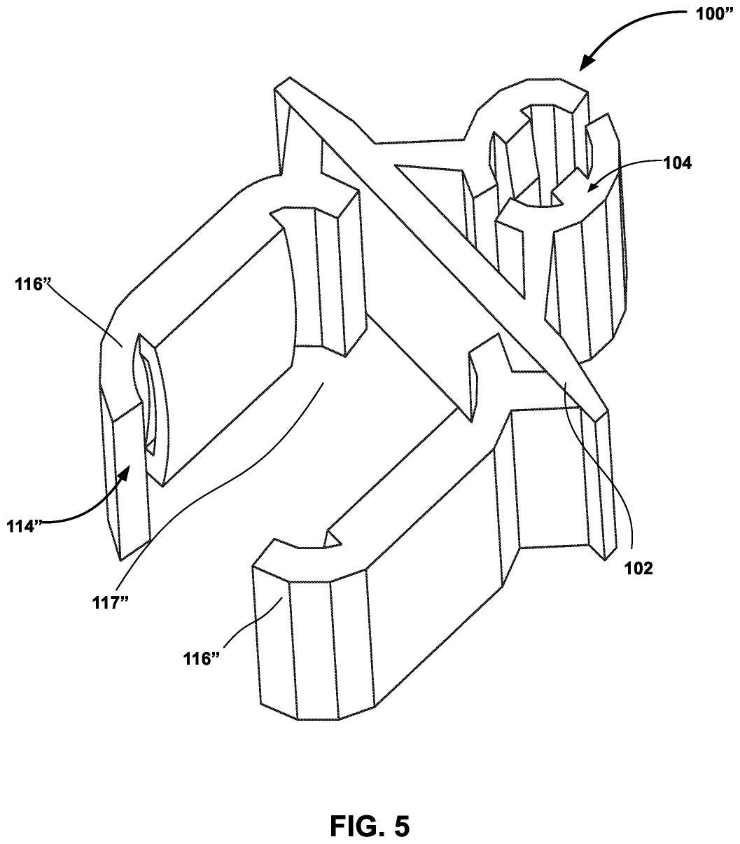

Referring to FIG. 5, an attachment clip 100″ is shown, according to another embodiment of the present invention, which is capable of being attached to an end of cord 20 (FIG. 1) or the like. The attachment clip 100″ is similar to the attachment clip 100 shown in FIG. 3 except for modifications associated with the geometrical features of the second through-hole and clamp portions of the attachment clip. The attachment clip 100″ comprises a base 102. A cord attachment portion 104 and an accessory attachment portion 114″ are disposed on opposite sides of the base 102. A second through-hole 117″ extends between clamp portions 116″.

As seen in FIG. 5, the second through-hole 117″ is enlarged compared to second through-hole 117 of FIG. 3. The clamp portions 116″ have a substantially elongate shape to accommodate accessories 120 of bigger shapes and sizes as compared to clamp portions 116 of FIG. 3. Further, the centering element 119″ is enlarged compared to centering element 119 of FIG. 3.further, each clamp portion 116″ has a base attachment portion 116a″ and a tip portion 116B″.

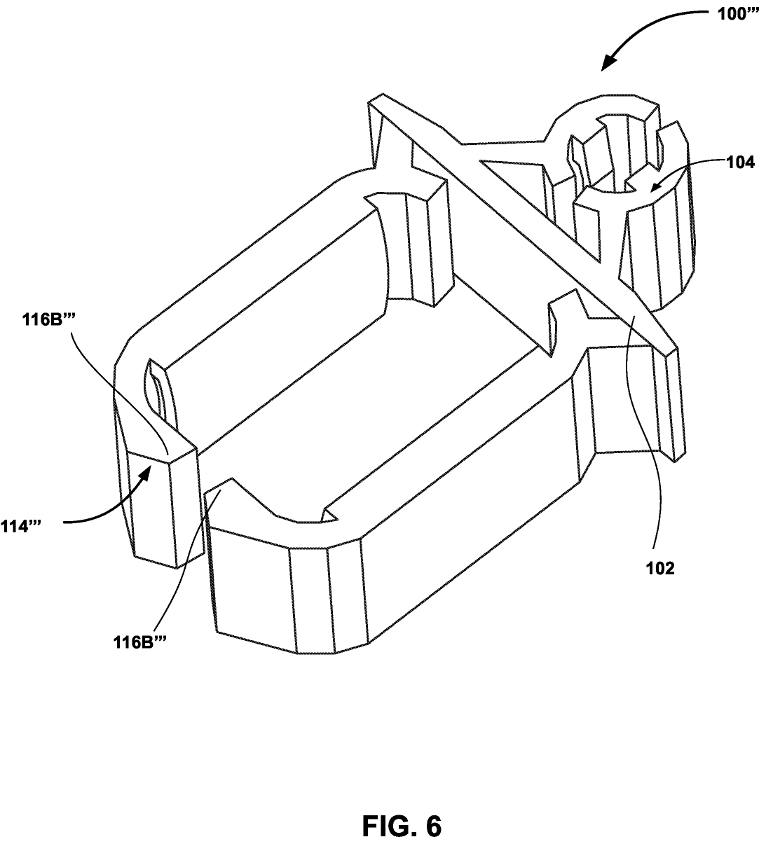

Referring to FIG. 6, an attachment clip 100″′ is shown, according to another embodiment of the present invention, which is capable of being attached to an end of cord 20 (FIG. 1) or the like. The attachment clip 100″′ is similar to the attachment clip 100″ shown in FIG. 5 except for modifications associated with the geometrical features of the tip portion of the clamp portions of the attachment clip. The attachment clip 100′″ comprises a base 102. A cord attachment portion 104 and an accessory attachment portion 114′″ are disposed on opposite sides of the base 102.

As seen in FIG. 6, the tip portion 116B′″ is bent inwardly compared to a tip portion 116B″ of FIG. 5. The tip portion 116B′″ is bent inwardly to safely retain (hold) accessories 120 in place as compared to FIG. 5.

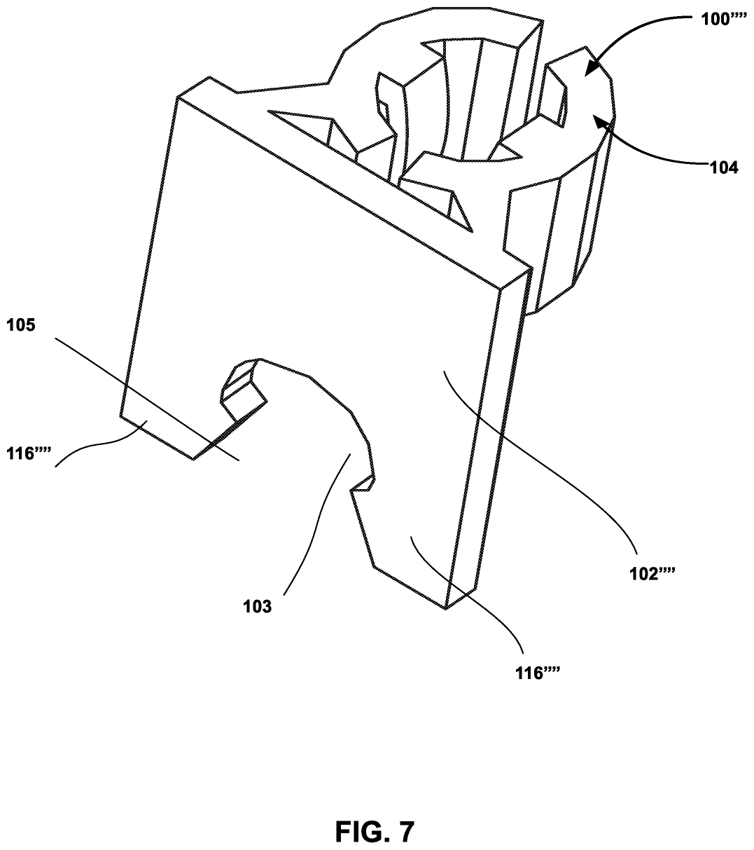

Referring to FIG. 7, an attachment clip 100″″ is shown, according to another embodiment of the present invention, which is capable of being attached to an end of cord 20 (FIG. 1) or the like. The attachment clip 100″″ is similar to the attachment clip 100″ shown in FIG. 3 except for modifications associated with the geometrical features of the accessory attachment portion and base of the attachment clip.

As seen in FIG. 7, the attachment clip 100″″ comprises a slotted base 102″″ and a cord attachment portion 104. The slotted base 102″″ has a substantially planer construction and the slotted base 102″″ comprises two clamp portions 116″″. A base hole 103 is formed between two clamp portions 116″″ to retain at least a portion of accessory 120. The slotted base 102″″ further comprise a v-shaped passage 105 to provide a passageway for one or more accessories 120 (FIG. 1) or the like from an external location to base hole 103 and vice versa. The shape of the base hole 103 is circular, however, in other embodiments (not shown in figure), the base hole 103 could have any shape including but not limited to: square, rectangle, triangle, hexagon and so on. The attachment clip 100″″ as seen in FIG. 7 does not include any accessory attachment portion as compared to FIG. 3.instead, at least a portion of accessory 120 (FIG. 1) is retained by the slotted base 102″″. In an embodiment, clamp portions 116″″ are made of a substantially flexible material to allow insertion of at least a portion of accessory 120 (FIG. 1) in the base hole 103 and vice versa.

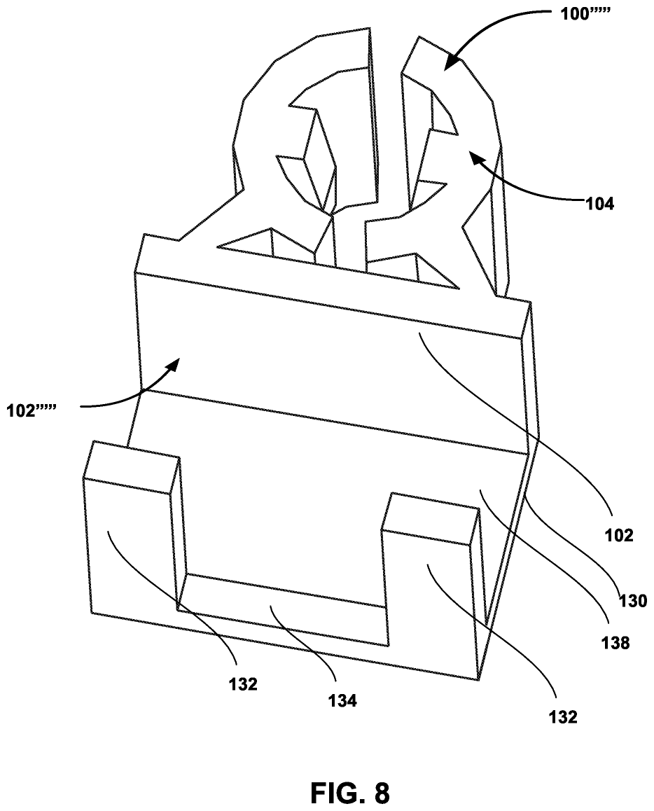

Referring to FIG. 8, an attachment clip 100′″″ is shown, according to another embodiment of the present invention, which is capable of being attached to an end of cord 20 (FIG. 1) or the like. The attachment clip 100″″′ is similar to the attachment clip 100″ shown in FIG. 7 except for modifications associated with the geometrical features of the base of the attachment clip. As seen in FIG. 8, the attachment clip 100″″ comprises a modified base 102″″′. The modified base 102″″′ comprises a base 102 similar to base 102 as in FIG. 3. Further, the modified base 102″″′ comprises a sidewall 130 arranged substantially perpendicular to the base 102. At least two raised projections 132 extend from the sidewall 130 such that at least a gap 134 is formed between the raised projections 132. The sidewall 130, base 102 and at least two raised projections 132 are arranged to define a cavity 138. The cavity 138 and/or the gap 134 provide means to retain at least a portion of accessory 120 (FIG. 1).

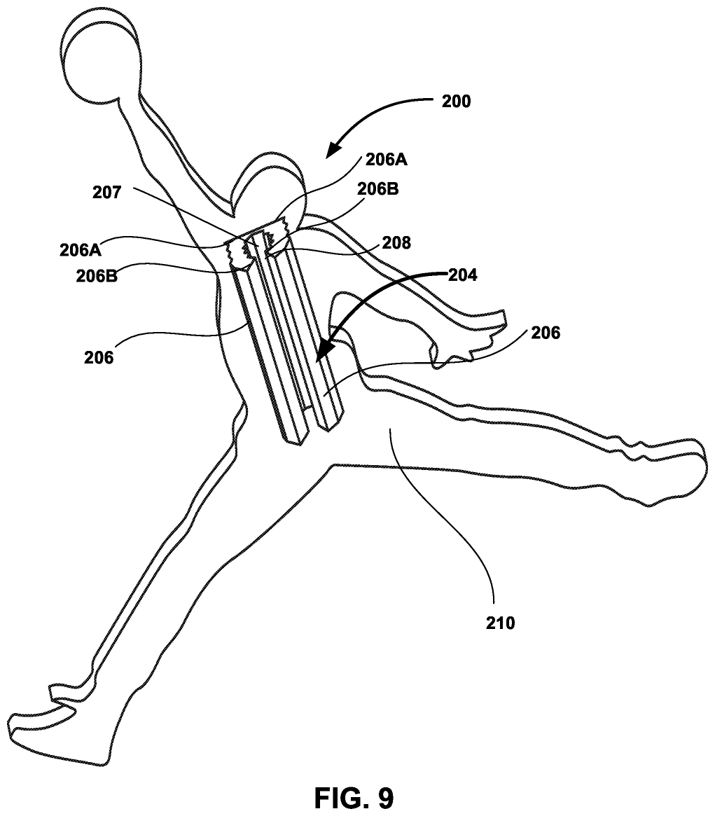

Referring to FIG. 9, an attachment clip 200 is illustrated, according to another embodiment of the present invention. The attachment clip 200 is secured to an end of cord 20 (FIG. 2). The attachment clip 200 comprises a cord attachment portion 204 and a decorative element 210. The cord attachment portion 204 is connected to the decorative element 210. In an embodiment, the cord attachment portion 204 is fixedly connected to the decorative element 210. In another embodiment, the cord attachment portion 204 is detachably connected to the decorative element 210. The decorative element 210 provides aesthetic appeal and/or decorative effect to the attachment clip 200.

In the embodiment illustrated in FIG. 2 and FIG. 9, decorative element 210 have an external configuration in the form of a basketball player playing with a basketball. In another embodiments, the decorative element 210 could have a variety of external configurations, including objects having different three-dimensional geometrical shapes including, without limitation, spheres, polygons, ball configurations (e.g., basketballs, soccer balls, baseballs, and the like), other sporting goods configurations (e.g., hockey pucks, footballs, rugby balls, and the like), three dimensional character configurations (e.g., cartoon characters, animated movie characters, sports, entertainment and popular culture figures, logo configurations, and the like), and other three-dimensional configurations representing animals, objects, and the like. The decorative element 210 may be provided in a wide variety of sizes as well as three dimensional shapes. In some other embodiments, the decorative element 210 can include a figure, a symbol, writing, an animal, advertisement items and LED lights and so on. For example, the decorative element 210 can include specialized or custom sizes, shapes or colors designed by the user.

The cord attachment portion 204 comprises two jaw portions 206. Each jaw portion 206 has a clip attachment portion 206A and a tip portion 206B on the opposite side. A through-hole 207 extends between the jaw portions 206. An aperture 208 is formed between the tip portions 206B of both opposing jaw portions 206. The aperture 208 provides a passageway for one or more cords 20 (FIG. 2) or the like from an external location to through-hole 207 and vice versa. The through-hole 207 is generally dimensioned and configured to accommodate and permit passage of the full dimensions of one or more cords 20 (FIG. 2) or the like. As seen in FIG. 9, the inner side of each jaw portion 206, facing the opposite jaw portion 206, has a corrugated profile. The corrugated profile of each jaw portion 206 is useful for providing a strong gripping force to the cords 20 (FIG. 2). The corrugated profile of each jaw portion 206 also ensures multiple point of contact of the jaw portions 206 with the cords 20 (FIG. 2).

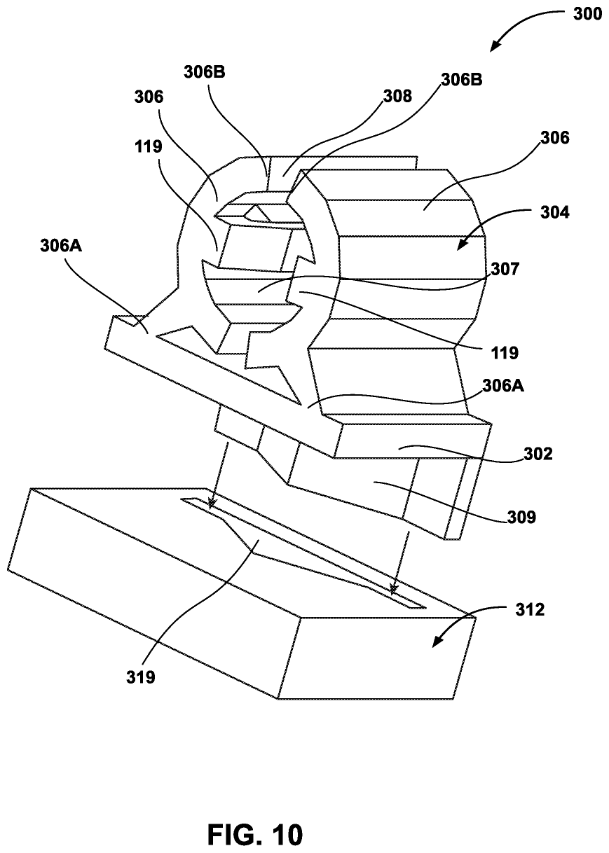

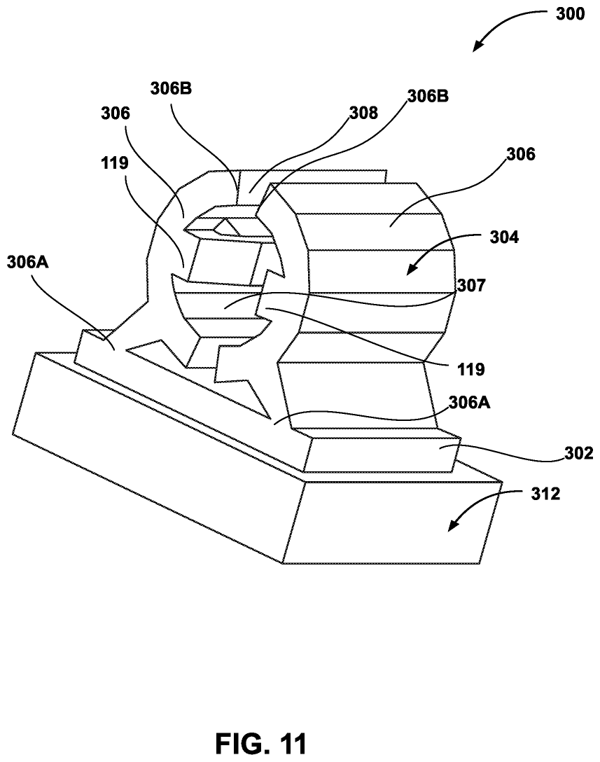

Referring to FIG. 10 and FIG. 11, a modular two-piece attachment clip 300 is illustrated, according to another embodiment of the present invention. The modular two-piece attachment clip 300 comprises a cord attachment portion 304 and an attachment element 312.

The cord attachment portion 304 comprises two jaw portions 306 and a base 302. Each jaw portion 306 has a base attachment portion 306A and a tip portion 306B on the opposite side. A first through-hole 307 extends between the jaw portions 306. A first aperture 308 is formed between the tip portions 306B of both opposing jaw portions 306. The first aperture 308 provides a passageway for one or more cords 20 (FIG. 1) or the like from an external location to first through-hole 307 and vice versa. First through-hole 307 is generally dimensioned and configured to accommodate and permit passage of the full dimensions of one or more cords 20 (FIG. 1) or the like. The base 302 comprises a connection portion 309 configured to removably mate with a connector element 319 of the attachment element 312. As seen in FIG. 9, the connection portion 309 is triangle shaped protrusion and the connector element 319 is a triangle shaped cavity. In another embodiments (not shown in figures), the shape of the connection portion 309 and the connector element 319 and/or the connector element 319 is circle, rectangle, hexagon, and pentagon and so on.

Both jaw portions 306 further include a centering element 119 disposed substantially in midway of inner side of each jaw portion 306. The centering element 119 provides various functions and/or advantages. The centering element 119 keeps the cords 20 (FIG. 1) or the like in a centered position. Further, the centering element 119 securely holds the cords 20 (FIG. 1) or the like in the first through-hole 307 such that the attachment clip 300 does not accidentally slip or fall out when the attachment clip 300 is attached to cords 20 (FIG. 1) or the like. The jaw portion 306 has a substantially c-shape, however, other shapes of jaw portion 306 is possible and can include shapes such as: l shape, v shape, i shape, zigzag shape and so on.

The attachment element 312 comprises a connector element 319 configured to removably mate with a connection portion 309 of the cord attachment portion 304. The connector portion 309 and/or connector element 319 comprises surface features which facilitate removable connection and disconnection of the attachment element 312 and the cord attachment portion 304. The surface features could include but not limited to: male-female projections, friction locks, snap-fit locks, key and keyways, pins, screws, luer-locks and so on.

In an embodiment, the attachment element 312 could include either a cord attachment portion 304 (not shown in figures) similar to cord attachment portion 104 of FIG. 3 or a decorative element 310 (not shown in figures) similar to decorative element 210 of FIG. 9. Alternatively, in another embodiment (not shown in figures), the attachment element 312 could include a combination of the cord attachment portion 304 and the decorative element 310. Alternatively, in another embodiment, the attachment element 312 could include an accessory 120 (FIG. 1).

As seen in FIG. 10, the modular attachment clip 300 of the present invention is shown in the disassembled state. Afterwards, the attachment element 312 and the cord attachment portion 304 are engaged against each other by connecting the connector portion 309 of the base 302 with the connector element 319 of the attachment element 312 as seen in FIG. 11.

It should be understood that the term “cord” 20 is an object that can be removably inserted in the attachment clip (100, 100′, 100″, 100″″. 100″″, 100″″′, 200, 300). The cord 20 generally comprises a substantially elongate object that could be flexible, rigid, semi-rigid or so on. In various embodiments, cord 20 can include but not limited to: drawstrings, laces, strings, wires, electronic items, necklace, threads, cables and so on. The cord 20 could have any cross sectional shape but not limited to: circle, square, rectangle, triangle, and hexagon and so on.

In some embodiments, the attachment clip (100, 100′, 100″, 100′″. 100″″, 100″″′, 200, 300) of the present invention is made of a substantially flexible material to allow insertion of cord 20 in the attachment clip (100, 100′, 100″, 100′″. 100″″, 100″″′, 200, 300). The flexible material could include but not limited to: rubber, plastic, polymers, natural materials and so on. In some embodiments, attachment clips as described herein may be constructed from multiple materials having different properties. In one embodiment, for example, base of attachment clips may be constructed from one or more materials having higher rigidity (and higher durometer) properties, while cord attachment portion and accessory attachment portion may be constructed from one or more materials having lower (relative) rigidity (and lower durometer) properties. The attachment clips as described herein could be any fabricated by any suitable technique and/or process and it could include injection molding, casting, 3D printing and so on.

It should be understood according to the preceding description of the present invention that the same is susceptible to changes, modifications and adaptations, and that the said changes, modifications and adaptations fall within scope of the appended claims.

What is claimed is:

1. An attachment clip (100, 100′, 100″, 100″′. 100″″, 100″″′) configured for mounting on a cord (20), wherein the attachment clip (100, 100′, 100″, 100″′. 100″″, 100″″′) comprising:
a base (102);
a cord attachment portion (104) and an accessory attachment portion (114) disposed on opposite sides of the base (102);
Wherein the cord attachment portion (104) comprises two jaw portions (106) wherein each Jaw portion (106) has a base attachment portion (106A) and a tip portion (106B) on the opposite side;
a first through hole (107) extending between the jaw portions (106); and a first aperture (108) formed between the tip portions (106B) of both opposing jaw portions (106);
Wherein the accessory attachment portion (114) is configured for retaining at least an accessory (120); and
Wherein each jaw portion (106) further includes a centering element (119) disposed in each jaw portion (106).

2. The attachment clip (100, 100′, 100″, 100″′. 100″″, 100″″′) according to claim 1, wherein the accessory (120) comprises at least one item selected from: a pen, an ear bud, a light, a key, a bottle, a mini-speaker, a pencil and a bracelet.

3. The attachment clip (100, 100′, 100″, 100″′. 100″″, 100″″′) according to claim 1, wherein the cord (20) comprises at least one item selected from: a drawstring, a lace, a string, a wire, an electronic item, a necklace, a thread and a cable.

4. The attachment clip (100, 100′, 100″, 100″′. 100″″, 100″″′) according to claim 1, wherein the centering element (119) is positioned in midway of inner side of each jaw portion (106).

5. An attachment clip (200) configured for mounting on a cord (20), wherein the attachment clip (200) comprising:
a cord attachment portion (204) connected to a decorative element (210);
Wherein the cord attachment portion (204) comprises two jaw portions (206) wherein each Jaw portion (206) has a clip attachment portion (206A) and a tip portion (206B) on the opposite side;
a through hole (207) extending between the jaw portions (206); and an Aperture (208) formed between the tip portions (206B) of both opposing jaw portions (206); and
Wherein the inner portion of each jaw portion (106) has a corrugated profile for gripping the cord (20).

6. The attachment clip (200) according to claim 5, wherein the decorative element (210) comprises at least one item selected from: spheres, polygons, ball configurations, sporting goods configurations, three dimensional character configurations, animals, figures, symbols, writing , advertisement items and LED lights and so on.

7. A modular two-piece attachment clip (300) configured for mounting on a cord (20), wherein the modular two-piece attachment clip (300) comprising:
a cord attachment portion (304) removably connected to an attachment element (312);
Wherein the cord attachment portion (304) comprises two jaw portions (306) and a base (302);
Wherein each Jaw portion (306) has a clip attachment portion (306A) and a tip portion (306B) on the opposite side;
a through-hole (307) extending between the jaw portions (306); and an aperture (308) formed between the tip portions (306B) of both opposing jaw portions (306);
Wherein each jaw portions (306) includes a centering element (119) disposed in inner side of each jaw portion (106);
Wherein the attachment element (312) comprises a connector element (319); and
Wherein , the base (302) further comprises a connection portion (309) for removable connection to the connector element (319) of the attachment element (312).

8. The modular two-piece attachment clip (300) according to claim 7, wherein the connector element (319) and/or connection portion (309) comprises surface features selected from a group consisting of: male-female projections, friction locks, snap-fit locks, key and keyways, pins, screws and luer-locks.

9. The modular two-piece attachment clip (300) according to claim 7, wherein the attachment element (312) could include an item selected from a group consisting of:
A cord attachment portion (304), a decorative element (310), a combination of the cord attachment portion and the decorative element, and an accessory (120).

10. The modular two-piece attachment clip (300) according to claim 7, wherein the centering element (119) is positioned in midway of inner side of each jaw portion (306).
